(19) United States
(12) Patent Application Publication
(10) Pub. No.: US 2026/0050523 A1
(43) Pub. Date: Feb. 19, 2026

(54) ELECTRONIC SYSTEM FOR ERROR DETECTION AND REMEDIATION IN ARTIFICIAL INTELLIGENCE GENERATIVE ENGINES

(71) Applicant: BANK OF AMERICA CORPORATION, Charlotte, NC (US)

(72) Inventors: Jo-Ann Taylor, Godalming, Surrey (GB); Jinna Kim, Charlotte, NC (US)

(73) Assignee: BANK OF AMERICA CORPORATION, Charlotte, NC (US)

(21) Appl. No.: 18/803,177

(22) Filed: Aug. 13, 2024

(51) Int. Cl. G06F 11/14; G06N 3/045; G06N 3/0475

(52) U.S. Cl. CPC G06F 11/1476; G06N 3/045; G06N 3/0475

(57) ABSTRACT

The present invention relates to apparatuses, systems, methods and computer program products for error detection and remediation in artificial intelligence generative engines. The system typically is structured for network flow circuit arrangement with counter-processing engine components for localizing errors, detecting inaccurate basis in training data, and validating data generated in a distributed network. In some aspects, the system comprises a first artificial intelligence engine network structured for generating output data based on affirmative indicator processing, The system further comprises a second artificial intelligence engine network operatively connected to the first artificial intelligence engine network, wherein the second artificial intelligence engine network is structured to challenge the challenge the first artificial intelligence engine for error detection based on negative indicator processing. Upon identifying a defect, the system is structured to process remediation actions at the first artificial intelligence engine network.

### FIELD

In general, embodiments of the invention are directed to error detection and remediation in artificial intelligence (AI) generative engines. In particular, in invention is structured for network flow circuit arrangement with counter-processing engine components for localizing errors, such as computing hallucinations, detecting inaccurate basis in training data, and validating data generated in a distributed network.

### BACKGROUND

Artificial intelligence generative engines are typically associated with neural networks, large language models, machine learning models, and the like. In general, artificial intelligence generative engines ingest and identify patterns in large quantities of training data, and subsequently constructs output content that has similar patters to that identified in the training data. Here, artificial intelligence generative engines are trained over a particular set of data, allowing the engine to reason and learn from the set of data, such as identifying patterns, groupings of attributes, correlation between data, and the like. As a result of the learning, the machine learning models are able to output a predicted result for the set of data. The artificial intelligence generative engines can generate content in the form of text, images, videos, and computer code.

However, artificial intelligence generative engines are innately prone to variety of errors such as computing hallucinations, where the engine perceives patterns or objects that are nonexistent and thereby constructs incorrect, irrelevant or nonsensical outputs. These computing hallucinations are typically caused due to limitations in training data and architecture of the artificial intelligence generative engines. In computing hallucinations, artificial intelligence generative engines output non-sensical answers to reasonable questions or vice versa. In conventional systems and networks, these instances of hallucinations are difficult to identify, if not impossible, before the defective output is processed in downstream systems causing cascading errors and malfunctions. Thus, there exists a need for assessing outputs generated by artificial intelligence generative engines.

The previous discussion of the background to the invention is provided for illustrative purposes only and is not an acknowledgement or admission that any of the material referred to is or was part of the common general knowledge as at the priority date of the application.

### BRIEF SUMMARY

Embodiments of the present invention address the above needs and/or achieve other advantages by providing a computerized system, and an associated method and computer program product, for error detection and remediation in artificial intelligence generative engines. Specifically, in some embodiments, the invention is structured for network flow circuit arrangement with counter-processing engine components for localizing errors, detecting inaccurate basis in training data, and validating data generated in a distributed network. In some embodiments, the system comprises a first artificial intelligence engine network, comprising a first artificial intelligence engine structured for generating output data based on affirmative indicator processing. The system further comprises a second artificial intelligence engine network operatively connected to the first artificial intelligence engine network, wherein the second artificial intelligence engine network is structured to challenge the challenge the first artificial intelligence engine for error detection based on negative indicator processing. The system may also comprise a third artificial intelligence engine network operatively connected to the first artificial intelligence engine network and the second artificial intelligence engine network. The system further comprises a downstream processing network connected at a location downstream to the first artificial intelligence engine network. In some embodiments the system comprises a computer apparatus including a memory device with computer-readable program code stored thereon, a communication device is configured to establish operative communication with a plurality of networked devices via a communication network, and a processing device operatively coupled to the memory device and the communication device configured to execute the computer-readable program code.

In some embodiments, the system is configured for error detection and remediation in artificial intelligence generative engines. In this regard, the system is configured to: receive, from a first processing device, a first input at the first artificial intelligence engine network; construct, via the first artificial intelligence engine, a first output based on detecting one or more affirmative indicators between the first output and first training data associated with the first artificial intelligence engine network; capture, via the second artificial intelligence engine network, the first output from the first artificial intelligence engine network to a downstream processing network; detect, at the second artificial intelligence engine network, negative indicators in the first output from the first artificial intelligence engine network based on processing at least the first output from the first artificial intelligence engine network and the first input; based on the identified negative indicators, identify, at the second artificial intelligence engine network a first error associated with the first artificial intelligence engine; identify, at the second artificial intelligence engine network, a first defect at (i) training data associated with the first artificial intelligence engine network, and/or (ii) processing at the first artificial intelligence engine, such that the defect is the source of the first error; in response to identifying the first defect, block transmission of the first output from the first artificial intelligence engine to the downstream processing network; and process, at a first network device, one or more remediation actions for remediating the first defect at the first artificial intelligence engine network.

In some embodiments, or in combination with the previous embodiment, identifying the first error based on the identified negative indicators by the second artificial intelligence engine network further comprises: transmitting, by the second artificial intelligence engine network, an interrogatory input to the first artificial intelligence engine structured to trigger a response from the first artificial intelligence engine regarding (i) source data utilized to generate the first output, and/or (ii) one or more discarded solutions associated with the first input.

In some embodiments, or in combination with any of the previous embodiments, detecting the negative indicators in the first output by the second artificial intelligence engine network, further comprises: dividing, at the second artificial intelligence engine network, the first output into a plurality of first output components; identifying first ground truth data associated at least one output component of the plurality of first output components; determining a deviation between the first ground truth data and the at least one output component of the plurality of first output components; and detecting the negative indicators in the first output based on determining that the deviation between the first ground truth data and the at least one output component is above a deviation degree threshold.

In some embodiments, or in combination with any of the previous embodiments, the first artificial intelligence engine network is trained based on a first training mode, and the second artificial intelligence engine network is trained based on a second training mode different from the first training mode.

In some embodiments, or in combination with any of the previous embodiments, blocking transmission of the first output from the first artificial intelligence engine to the downstream processing network further comprises: inserting, at the first output, an error code data in the metadata of the first output prior to transmission of the first output to the downstream processing network; transmitting the first output from the first artificial intelligence engine to the downstream processing network; identifying, at the downstream processing network, the error code data upon processing of the first output; and modifying, at the downstream processing network, the processing of the first output based on the error code data.

In some embodiments, or in combination with any of the previous embodiments, the invention further comprises: capturing a second output generated by the first artificial intelligence engine, wherein the second output is generated at a time subsequent to the first output; and inserting, at the second output, the error code data in the metadata of the second output prior to transmission of the second output to the downstream processing network.

In some embodiments, or in combination with any of the previous embodiments, blocking transmission of the first output from the first artificial intelligence engine to the downstream processing network further comprises: modifying metadata of the first output prior to transmission of the first output to the downstream processing network, wherein modifying the metadata of the first output comprises inserting distortions in the metadata such that the first output is unusable by the downstream processing network or a system/device of the downstream processing network (referred to as a downstream processing system).

In some embodiments, or in combination with any of the previous embodiments, the invention is further configured to: transmit, to the first artificial intelligence engine, an operative signal to cause the first artificial intelligence engine to reconstruct the first output based on validating completion of one or more remediation actions for remediating the first defect; construct, at the first artificial intelligence engine, a second output based on the first input and one or more remediation actions for remediating the first defect; validate, at the second artificial intelligence engine network, the second output based on identifying no defects; and allow transmission of the second output from the first artificial intelligence engine to the downstream processing network based on successful validation of the second output by the second artificial intelligence engine network.

In some embodiments, or in combination with any of the previous embodiments, the invention is further configured to: construct, via the second artificial intelligence engine network, a second output based on the first input; construct, via the third artificial intelligence engine network, output variance data associated with inconsistencies between the first output from the first artificial intelligence engine and the second output from the second artificial intelligence engine network; and present, at a display device of the first network device, the output variance data.

In some embodiments, or in combination with any of the previous embodiments, the invention is further configured to: construct a remediation user interface associated with the identified first defect of the first artificial intelligence engine network, wherein the user interface is structured to queue one or more subsequently identified second defects of the first artificial intelligence engine network and associated second outputs from the first artificial intelligence engine network; present, at a display device of the first network device, the remediation user interface, such that the queue is periodically updated; and receive, via the remediation user interface, a first input associated with the first defect of the first artificial intelligence engine network.

In some embodiments, or in combination with any of the previous embodiments, the first input is associated with validation of the first output associated with the first defect. Here, the invention is further configured to: in response to the first input, remove the block associated with transmission of the first output from the first artificial intelligence engine; and transmit the first output from the first artificial intelligence engine to the downstream processing network.

In some embodiments, or in combination with any of the previous embodiments, the invention is further configured to: receive, from the first processing device, a second input at the first artificial intelligence engine network; transmit, in parallel, the second input to the first artificial intelligence engine and the second artificial intelligence engine network; construct, via the first artificial intelligence engine, a second output based on detecting one or more affirmative indicators between the second output and first training data associated with the first artificial intelligence engine network; construct, via the second artificial intelligence engine network, in parallel to the first artificial intelligence engine, a third output based on the second input; construct, via a third artificial intelligence engine network, output variance data associated with inconsistencies between the first output from the first artificial intelligence engine and the second output from the second artificial intelligence engine network; and present, at a display device of the first network device, the output variance data.

### BRIEF DESCRIPTION OF THE DRAWINGS

Having thus described embodiments of the invention in general terms, reference will be made to the accompanying drawings, where:

FIG. 1 illustrates a block diagram of the system environment 100 for error detection and remediation in artificial intelligence generative engines, in accordance with some embodiments of the invention;

FIG. 2A illustrates a schematic depiction 200A of a network flow circuit arrangement with counter-processing engine components, in accordance with some embodiments of the invention;

FIG. 2B illustrates a schematic depiction 200B of a network flow circuit arrangement with counter-processing engine components, in accordance with some embodiments of the invention;

FIG. 2C illustrates a schematic depiction 200C of a network flow circuit arrangement with counter-processing engine components, in accordance with some embodiments of the invention;

FIG. 3 illustrates a high level process flow 300 for error detection and remediation in artificial intelligence generative engines, in accordance with some embodiments of the invention;

FIG. 4 illustrates a high level process flow 400 for error detection and remediation in artificial intelligence generative engines via variance analysis using a third artificial intelligence engine, in accordance with some embodiments of the invention; and

FIG. 5 illustrates a high level process flow 500 for error detection and remediation in artificial intelligence generative engines via parallel processing, in accordance with some embodiments of the invention.

### DETAILED DESCRIPTION OF THE INVENTION

Embodiments of the present invention will be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

In some embodiments, a “user” may be an individual associated with an enterprise or entity. In some embodiments, a “user” may be an employee (e.g., an associate, a project manager, an IT specialist, a manager, an administrator, an internal operations analyst, or the like) of the entity or enterprises affiliated with the entity, capable of operating the system described herein. In some embodiments, a “user” may be any individual or entity who has a relationship with the enterprise. For purposes of this invention, the terms “user” and “customer” may be used interchangeably. In some embodiments, a “user” may be a customer of the enterprise. In one aspect, a user may be a system performing one or more tasks described herein.

In some embodiments, an “entity” or “enterprise” as used herein may be any institution employing information technology resources. In some embodiments the enterprise may be any institution, group, association, business, financial institution, club, establishment, company, union, authority or the like, employing information technology resources.

As used herein, a “user interface” may be a graphical user interface. Typically, a graphical user interface (GUI) is a type of interface that allows users to interact with electronic devices such as graphical icons and visual indicators such as secondary notation, as opposed to using only text via the command line. In some embodiments, the graphical user interface may include both graphical elements and text elements.

Typically, an entity or enterprise is associated with a plurality of information technology operational activities. The “information technology operational activities,” as referred to herein, may comprise any activities, operations, transactions, technology change activities, technology incidents, actions and events associated with day-to day functioning of an entity, operations and control activities of technology resources of the entity, external networks of the entity, activities performed/initiated by employees, affiliates and customers of the entity, and the like. In some embodiments, the information technology operational activities may comprise operational activities associated with system hardware, operating systems, servers, technology applications, internal networks, storage/databases, user interfaces, authentication operations, middleware, software program products, external networks, software applications, hosting/facilities, business/technology processes, electrical infrastructure, and other technology resources associated with the entity. In some embodiments, the information technology operational activities may be associated with transactional activities of the enterprise, comprising technology changes, technology events, technology maintenance activities, technology incidents, technology problems, technology releases, technology service requests, technology projects, configuration activities, technology resource management activities, vendor transactions and the like.

“Network program resource components”, “network resource components”, “program resources”, or “resources” as used herein may refer to computer programs, applications (e.g., desktop applications, web applications, etc.), deployment executables (including binaries, packages, patches, and other relevant software media), software, firmware, application software, system software, operating systems, device drivers, utilities, server software, embedded software, microcode, plugins, programming tools and applications, and/or other computer programs or software or combinations of the foregoing.

Artificial intelligence generative engines are typically associated with neural networks, large language models, machine learning models, and the like. In general, artificial intelligence generative engines ingest and identify patterns in large quantities of training data, and subsequently constructs output content that has similar patters to that identified in the training data. Here, artificial intelligence generative engines are trained over a particular set of data, allowing the engine to reason and learn from the set of data, such as identifying patterns, groupings of attributes, correlation between data, and the like. As a result of the learning, the machine learning models are able to output a predicted result for the set of data. The artificial intelligence generative engines can generate content in the form of text, images, videos, and computer code.

However, artificial intelligence generative engines are innately prone to variety of errors such as computing hallucinations, where the engine perceives patterns or objects that are nonexistent and thereby constructs incorrect, irrelevant or nonsensical outputs. These computing hallucinations are typically caused due to limitations in training data and architecture of the artificial intelligence generative engines. In computing hallucinations, artificial intelligence generative engines output non-sensical answers to reasonable questions or vice versa. In conventional systems and networks, these instances of hallucinations are difficult to identify, if not impossible, before the defective output is processed in downstream systems causing cascading errors and malfunctions.

Conventional artificial intelligence generative engines are not structured for evaluating fully trained models, i.e., models whose training is complete. Moreover, conventional artificial intelligence generative engines are typically associated with a serverless infrastructure. Here, conventional testing and evaluation methods involving output analysis and training processes undesirably cause an increased startup latency. Moreover, conventional testing and evaluation methods impede the processing of the artificial intelligence generative engine being evaluated.

The present invention provides solutions to the foregoing problems in existing technology, alleviates the foregoing deficiencies in existing technology, and provides additional advantages as well. The invention provides for a system that arranges a challenging artificial intelligence generative engine against an artificial intelligence generative engine that is constructing the solution or the output. In this way, the challenging artificial intelligence generative engines unveils where there is uncertainty in the solution/output at the artificial intelligence generative engines that is generating the output. The present invention allows for evaluation of artificial intelligence generative engine, including fully trained models, continuously, and in real-time. Moreover, the unique network flow circuit arrangement utilizing a second artificial intelligence engine network allows for error detection and remediation processes without adversely affecting the latency of the artificial intelligence generative engine being evaluated or causing delays in the processing of the artificial intelligence generative engine.

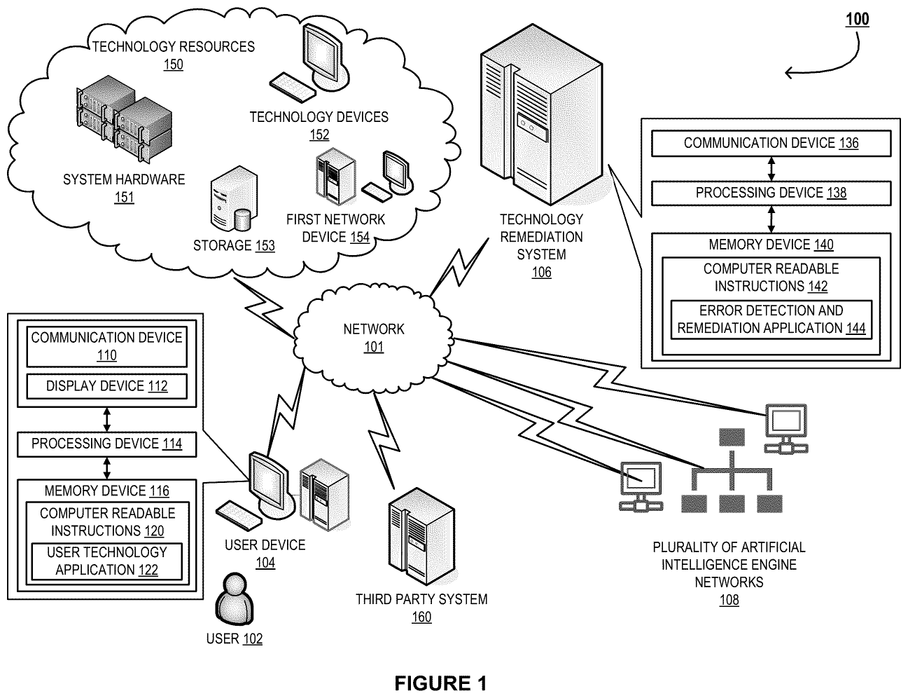

FIG. 1 illustrates a technology remediation system environment 100 for error detection and remediation in artificial intelligence generative engines, in accordance with one embodiment of the present invention. As illustrated in FIG. 1, the technology remediation system 106 is operatively coupled, via a network 101 to technology resources 150, a plurality of artificial intelligence engine networks 108, the user system/device 104 (also referred to as a first processing device 204), and to the third party system 160. The system environment 100 (e.g., excluding the third party system 160) may also be referred to as a distributed network associated with a particular entity, elsewhere in this disclosure.

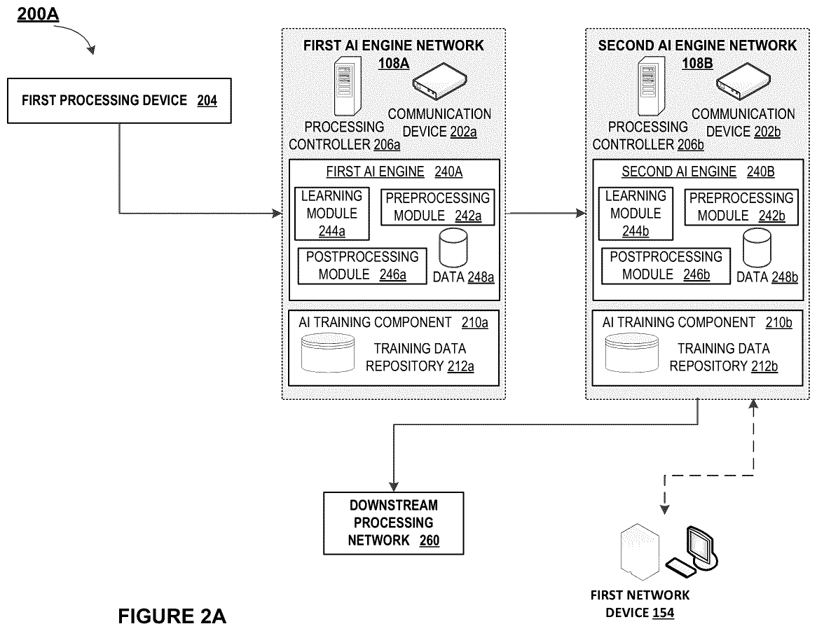

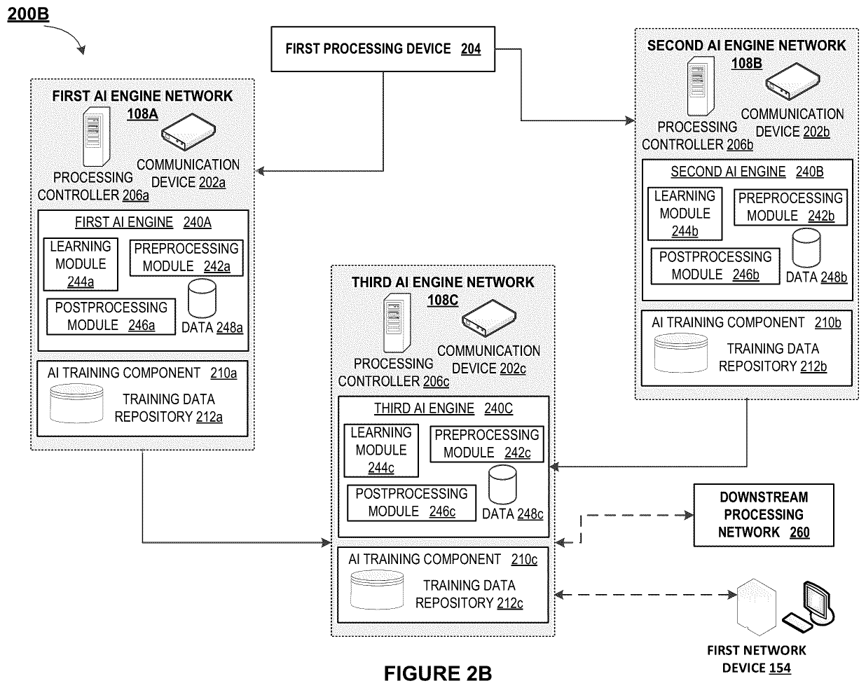

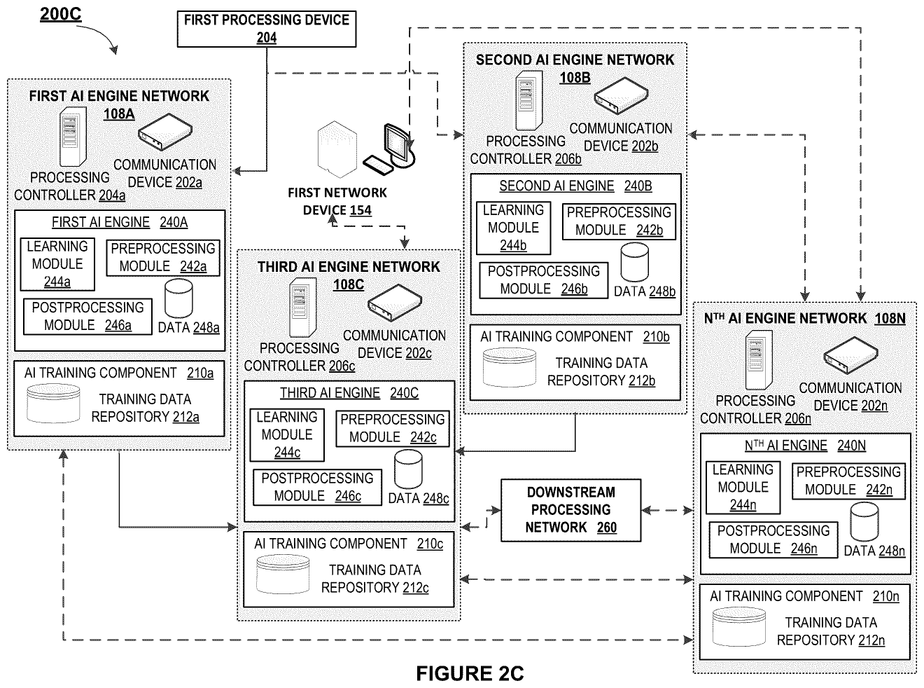

In some embodiments, the error detection and remediation in artificial intelligence generative engines, may be performed by the technology remediation system 106, e.g., in conjunction with the plurality of artificial intelligence engine networks 108, technology resources 150, and/or the user device 104. For example, the technology remediation system 106 may establish operative communication channels with each of the plurality of artificial intelligence engine networks 108 comprising a first artificial intelligence engine network 108A, second artificial intelligence engine network 108B, third artificial intelligence engine networks 108C, . . . and/or an N^{th} artificial intelligence engine network 108N, via the network 101. The technology remediation system 106 may establish operative communication channels with the technology resources 150 such as the system hardware 151, technology devices and applications 152, storage 153, and/or the first network device 154, via the network 101 (in some instances, as well as the third party system 160). The technology remediation system 106 may establish operative communication channels with downstream processing networks (such as downstream processing network 260 illustrated in FIGS. 2A-2C).

The technology remediation system 106 may then receive, from a first processing device 204, a first input at the first artificial intelligence engine network 108A. In some embodiments, a user system 104 (also referred to as a first processing device 204) may instruct the first artificial intelligence engine network 108A to generate an output, e.g., based on an input provided by the user 102. The system 106 may then construct, via the first artificial intelligence engine 240A, a first output based on detecting one or more affirmative indicators between the first output and first training data associated with the first artificial intelligence engine network 108A. the system 106 may capture, via the second artificial intelligence engine network 108B, the first output from the first artificial intelligence engine network 108A to a downstream processing network 260. The system 106 may then detect, at the second artificial intelligence engine network 108B, negative indicators in the first output from the first artificial intelligence engine network 108A based on processing at least the first output from the first artificial intelligence engine network 108A and the first input. Based on the identified negative indicators, the system 106 may identify, at the second artificial intelligence engine network 108B a first error associated with the first artificial intelligence engine 240A. The system 106 may then identify, at the second artificial intelligence engine network 108B, a first defect at (i) training data associated with the first artificial intelligence engine network 108A, and/or (ii) processing at the first artificial intelligence engine 240A, such that the defect is the source of the first error. In response to identifying the first defect, system 106 may block transmission of the first output from the first artificial intelligence engine 240A to the downstream processing network 260. The system 106 may process, at a first network device 154, one or more remediation actions for remediating the first defect at the first artificial intelligence engine network.

FIG. 1 illustrates a technology remediation system environment 100, in accordance with one embodiment of the present invention, configured for error detection and remediation in artificial intelligence generative engines, via network flow circuit arrangement with counter-processing engine components for localizing errors, detecting inaccurate basis in training data, and validating data generated in a distributed network. The technology remediation system 106 is operatively coupled, via a network 101 to technology resources 150, a plurality of artificial intelligence engine networks 108, the user system/device 104, to the third party system 160, and/or to downstream processing networks (such as downstream processing network 260 illustrated in FIGS. 2A-2C. In this way, the technology remediation system 106 can send information to, and receive information from the technology resources 150, the plurality of artificial intelligence engine networks 108, the user system 104, the third party system 160, and/or the downstream processing networks (such as downstream processing network 260 illustrated in FIGS. 2A-2C, to provide error detection and remediation in artificial intelligence generative engines. FIG. 1 illustrates only one example of an embodiment of the technology remediation system environment 100, and it will be appreciated that in other embodiments one or more of the systems, devices, or servers may be combined into a single system, device, or server, or be made up of multiple systems, devices, or servers.

The network 101 may be a global area network (GAN), such as the Internet, a wide area network (WAN), a local area network (LAN), near field communication network, audio/radio communication network, ultra-high frequency wireless communication network, or any other type of network or combination of networks. The network 101 may provide for wireline, wireless, or a combination wireline and wireless communication between devices on the network 101.

In some embodiments, the user 102 is an individual associated with the entity. In some embodiments, the user 102 may access the technology remediation system 106 through an interface comprising a webpage or a user technology application 122 (e.g., an application configured for presenting the user interface associated with a user device application API). Hereinafter, “user technology application” is used to refer to an application on the user system 104 of a user, a widget, a webpage accessed through a browser, and the like, and may provide a user interface. In some embodiments the user technology application 122 is a user system application stored on the user system 104. In some embodiments the user technology application may refer to a third party application or a user application stored on a cloud used to access the technology remediation system through a network. In some embodiments, at least a portion of the user technology application 122 is stored on the memory device 140 of the technology remediation system 106. The user 102 may subsequently navigate through the interface, view displayed data, and provide inputs therethrough. In some embodiments, the user device 104 may be referred to as a network device, and the user device 104 may be one of the technology devices 150.

FIG. 1 also illustrates the user system 104. The user system 104 generally comprises a communication device 110, a display device 112, a processing device 114, and a memory device 116. The user system 104 is a computing system that allows a user 102 to interact with the technology remediation system to a first input at the first artificial intelligence engine network 108A, view resulting outputs, etc. The processing device 114 is operatively coupled to the communication device 110, the display device 112, and the memory device 116. The processing device 114 uses the communication device 110 to communicate with the network 101 and other devices on the network 101, such as, but not limited to the plurality of artificial intelligence engine networks and the technology remediation system 106. As such, the communication device 110 generally comprises a modem, server, or other device for communicating with other systems/devices on the network 101. In some embodiments the network 101 comprises a network of distributed servers. The user system 104 comprises computer-readable instructions 120 stored in the memory device 116/data storage, which in one embodiment includes the computer-readable instructions 120 of the user technology application 122. In this way, a user 102 may communicate with the technology remediation system 106. The user system 104 may be, for example, a computing system, a desktop personal computer, a server system, a mobile system, such as a cellular phone, smart phone, personal data assistant (PDA), laptop, or the like. Although only a single user system 104 is depicted in FIG. 1, the system environment 100 may contain numerous user systems 104.

As further illustrated in FIG. 1, the technology remediation system 106 generally comprises a communication device 136, a processing device 138, and a memory device 140. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs or one or more modules, based on computer-readable instructions thereof, which may be stored in a memory device.

The processing device 138 is operatively coupled to the communication device 136 and the memory device 140. The processing device 138 uses the communication device 136 to communicate with the network 101 and other devices on the network 101, such as, but not limited to the plurality of artificial intelligence engine networks 108, the third party system 160 and the user system 104. As such, the communication device 136 generally comprises a modem, server, or other device for communicating with other devices on the network 101.

As further illustrated in FIG. 1, the technology remediation system 106 comprises computer-readable instructions 142 stored in the memory device 140, which in one embodiment includes the computer-readable instructions 142 of an error detection and remediation application 144 configured for error detection and remediation in artificial intelligence generative engines via network flow circuit arrangement with counter-processing engine components for localizing errors, detecting inaccurate basis in training data, and validating data generated in a distributed network.

As further illustrated by FIG. 1, the system environment 100 further comprises a plurality of artificial intelligence engine networks 108. The plurality of artificial intelligence engine networks 108 may comprise a first artificial intelligence engine network 108A, second artificial intelligence engine network 108B, third artificial intelligence engine networks 108C, . . . and/or an N^{th} artificial intelligence engine network 108N, as will be described in detail with respect to FIGS. 2A-2C.

The system environment 100 further comprises technology resources 150 comprising system hardware 151, technology devices and applications 152, operating systems, servers, technology applications, internal networks, storage/databases 153, user interfaces, authentication operations, middleware, program products, external networks, hosting/facilities, business/technology processes, and other technology resources associated with the entity. In some embodiments, the technology remediation system 106 communicates with the individual technology resources 150, via established operative communication channels. In this regard, the system 106 may transmit control instructions that cause the technology resources 150 or the artificial intelligence engine networks 108 to perform one or more actions, provide activity data, and the like. The technology resources 150 are typically configured to communicate with one another, other devices operated by the entity, and devices operated by third parties (e.g., customers), such as a third party computing device 160, via a network 101.

The first network device 154 may further comprise a display device having an interface comprising a webpage or a user technology application 122 (e.g., an application configured for presenting the user interface associated with a user device application API). In some embodiments, the first network device is substantially similar in structure and functions to the user system 104. Hereinafter, “user technology application” is used to refer to an application on the user system 104 of a user, a widget, a webpage accessed through a browser, and the like, and may provide a user interface such as an interface for presenting output variance data, a remediation user interface, and the like. A user 103 (not illustrated) (e.g., a user different than user 102) may subsequently navigate through the interface, view displayed data, and provide inputs therethrough. The user 103 may refer to employees, technical subject matter experts, operators and other personnel associated with the entity or affiliates of the entity. Moreover, in some embodiments, a user 103 may review output variance data generated by third artificial intelligence engine network 108C presented at a display device of the first network device 154, defects of the first artificial intelligence engine network 108A queued at a remediation user interface presented at a display device of the first network device 154, and/or the like and provide requisite inputs.

FIG. 2A illustrates a schematic depiction 200A of a network flow circuit arrangement with counter-processing engine components, in accordance with some embodiments of the invention. As illustrated herein, the network flow circuit arrangement comprises a first artificial intelligence engine network 108A, comprising a first artificial intelligence engine 240A. Typically, the first artificial intelligence engine 240A is structured for generating output data based on affirmative indicator processing. The first artificial intelligence engine network 108A further comprises a communication device 202a and a processing controller 206a. Typically, the communication device 202a generally comprises a modem, server, or other device for communicating with other artificial intelligence engine networks and other devices on the network 101. The processing controller 206a may comprise circuitry used for implementing the communication and/or logic functions of the first artificial intelligence engine network 108A, and may include a digital signal processor device, a microprocessor device, and various analog-to-digital converters, digital-to-analog converters, and other support circuits and/or combinations of the foregoing.

The first artificial intelligence engine network 108A comprises a pre-processing module 242a, a learning module 244a (e.g., a machine learning module, etc.), post-processing module 246a, and associate data storage component 248a. The first artificial intelligence engine network 108A may further comprise an AI training component 210a structured for training the first artificial intelligence engine 240A, and the learning module 244a in particular, using training data stored at the training data repository 212a. Here, the first artificial intelligence engine 108A structured for receiving input and generating output data based on affirmative indicator processing. The first artificial intelligence engine network 108A is used to suggest possible solutions to an input, with the first artificial intelligence engine network 108A predicated to search for affirmative indicators that a solution might be worthwhile. So, whilst the suggested solution might not be known as yet, new and innovative outputs/solutions may be generated. However, this inherently raises the problem of fundamentally flawed and untrue solutions/outputs.

In order to solve this problem, the present invention includes a second artificial intelligence engine network 108B, which is predicated to search for negative indicators. Here the second artificial intelligence engine network 108B may identify data which could indicate that the suggested solution is untrue. This could be accomplished by both challenging the first artificial intelligence engine network 108A to cite sources, known similar solutions, and the like, as well as to take elements of the first output/solution generated by the first artificial intelligence engine network 108A and to correlate against data to actively seek out the degree to which they differ from known truths. In this way, the present invention identifies where training and training data may have been selective or skewed. Typically, the first artificial intelligence engine network is trained based on a first training mode, and wherein the second artificial intelligence engine network 108B is trained based on a second training mode different from the first training mode.

As illustrated herein, the second artificial intelligence engine network 108B, comprising a second artificial intelligence engine 240B, operatively connected to the first artificial intelligence engine network (e.g., in a series arrangement). Typically, the second artificial intelligence engine 240B is structured for generating output data based on affirmative indicator processing. The second artificial intelligence engine network 108B further comprises a communication device 202b and a processing controller 206b. Typically, the communication device 202b generally comprises a modem, server, or other device for communicating with other artificial intelligence engine networks and other devices on the network 101. The processing controller 206b may comprise circuitry used for implementing the communication and/or logic functions of the second artificial intelligence engine network 108B, and may include a digital signal processor device, a microprocessor device, and various analog-to-digital converters, digital-to-analog converters, and other support circuits and/or combinations of the foregoing.

The second artificial intelligence engine network 108B comprises a pre-processing module 242b, a learning module 244b (e.g., a machine learning module, etc.), post-processing module 246b, and associate data storage component 248b. The second artificial intelligence engine network 108B may further comprise an AI training component 210b structured for training the second artificial intelligence engine 240B, and the learning module 244b in particular, using training data stored at the training data repository 212b. The second artificial intelligence engine network 108B is structured to challenge the challenge the first artificial intelligence engine 240A for error detection based on negative indicator processing.

Here, the first processing device 204 transmits a first input at the first artificial intelligence engine network 108A. Next, the first artificial intelligence engine 240A constructs a first output based on detecting one or more affirmative indicators between the first output and first training data associated with the first artificial intelligence engine network 108A. The second artificial intelligence engine network 108B captures the first output from the first artificial intelligence engine network 108A to a downstream processing network 260. The second artificial intelligence engine network 108B detects negative indicators in the first output from the first artificial intelligence engine network 108A based on processing at least the first output from the first artificial intelligence engine network 108A and the first input. Based on the identified negative indicators, the second artificial intelligence engine network 108B identifies at a first error associated with the first artificial intelligence engine 240A. The second artificial intelligence engine network 108B identifies a first defect at (i) training data associated with the first artificial intelligence engine network 108A, and/or (ii) processing at the first artificial intelligence engine 240A, such that the defect is the source of the first error. In response to identifying the first defect, transmission of the first output from the first artificial intelligence engine 240A to the downstream processing network 260 is blocked. The first network device 154 subsequently processes one or more remediation actions for remediating the first defect at the first artificial intelligence engine network.

FIG. 2B illustrates a schematic depiction 200B of a network flow circuit arrangement with counter-processing engine components, in accordance with some embodiments of the invention. Specifically, the schematic depiction 200B illustrates a parallel arrangement of the network flow circuit, with the first artificial intelligence engine network 108A (described previously with respect to FIG. 2A) and the second artificial intelligence engine network 108B (described previously with respect to FIG. 2A) undertaking parallel processing of an input to generate, in parallel two separate outputs, respectively. This parallel processing allows simultaneous generation of outputs which allows for reduced processing time. Moreover, the parallel processing provides parity between the artificial intelligence engine networks (108A, 108B) which allows for evaluating performance metrics such as how quickly each artificial intelligence engine network (108A, 108B) generates the output, how may rounds of inputs are required to refine the results in order to generate a certain output, and how many iterations of inputs are required in order to generate a certain output, for each artificial intelligence engine network (108A, 108B). A third artificial intelligence engine network 108C may then analyze the variance between the two separate outputs to detect defects in the output from the first artificial intelligence engine network 108A. Here, the third artificial intelligence engine network 108C may not only analyze defects in the output, but also redundant processing in the form of comparing the time taken by each of the first and second artificial intelligence engine networks (108A, 108B) to arrive at their respect outputs and/or the number of input prompts required by each of the first and second artificial intelligence engine networks (108A, 108B) to arrive at their respect outputs. In this way, the third artificial intelligence engine network 108C can identify improper processing conducted by the first artificial intelligence engine network 108A.

As illustrated herein, the network flow circuit arrangement comprises a third artificial intelligence engine network 108C, comprising a third artificial intelligence engine 240C. The third artificial intelligence engine network 108C further comprises a communication device 202c and a processing controller 206c. Typically, the communication device 202c generally comprises a modem, server, or other device for communicating with other artificial intelligence engine networks and other devices on the network 101. The processing controller 206c may comprise circuitry used for implementing the communication and/or logic functions of the third artificial intelligence engine network 108C, and may include a digital signal processor device, a microprocessor device, and various analog-to-digital converters, digital-to-analog converters, and other support circuits and/or combinations of the foregoing.

The third artificial intelligence engine network 108C comprises a pre-processing module 242c, a learning module 244c (e.g., a machine learning module, etc.), post-processing module 246c, and associate data storage component 248c. The third artificial intelligence engine network 108C may further comprise an AI training component 210c structured for training the third artificial intelligence engine 240C, and the learning module 244c in particular, using training data stored at the training data repository 212c.

The first processing device 204 transmits a second input at the first artificial intelligence engine network 108A. In parallel, the second input is also transmitted to the first artificial intelligence engine 240A and the second artificial intelligence engine network 108B.

The first artificial intelligence engine 240A constructs a second output based on detecting one or more affirmative indicators between the second output and first training data associated with the first artificial intelligence engine network 108A. Parallelly, the second artificial intelligence engine network 108B constructs, a third output based on the second input. The third artificial intelligence engine network 108C constructs an output variance data associated with inconsistencies between the first output from the first artificial intelligence engine 240A and the second output from the second artificial intelligence engine network 108B; and presents, at a display device of the first network device 154, the output variance data.

FIG. 2C illustrates a schematic depiction 200C of a network flow circuit arrangement with counter-processing engine components, in accordance with some embodiments of the invention. Specifically, the schematic depiction 200B illustrates a compound arrangement of the network flow circuit, involving the first and second artificial intelligence engine networks (108A, 108B) (described previously with respect to FIG. 2A) and the third artificial intelligence engine network 108C (described previously with respect to FIG. 2C). The compound arrangement may further comprise additional one or more artificial intelligence engine networks (indicated by a N^{th} artificial intelligence engine network 108N) in suitable series, parallel, or cascading arrangement with the artificial intelligence engine networks (108A, 108B, and 108C).

As illustrated herein, the network flow circuit arrangement comprises a N^{th} artificial intelligence engine network 108N, comprising a N^{th} artificial intelligence engine 240N. The N^{th} artificial intelligence engine network 108N further comprises a communication device 202n and a processing controller 206n. Typically, the communication device 202n generally comprises a modem, server, or other device for communicating with other artificial intelligence engine networks and other devices on the network 101. The processing controller 206n may comprise circuitry used for implementing the communication and/or logic functions of the N^{th} artificial intelligence engine network 108N, and may include a digital signal processor device, a microprocessor device, and various analog-to-digital converters, digital-to-analog converters, and other support circuits and/or combinations of the foregoing.

The N^{th} artificial intelligence engine network 108N comprises a pre-processing module 242n, a learning module 244n (e.g., a machine learning module, etc.), post-processing module 246n, and associate data storage component 248n. The N^{th} artificial intelligence engine network 108N may further comprise an AI training component 210n structured for training the N^{th} artificial intelligence engine 240N, and the learning module 244n in particular, using training data stored at the training data repository 212n.

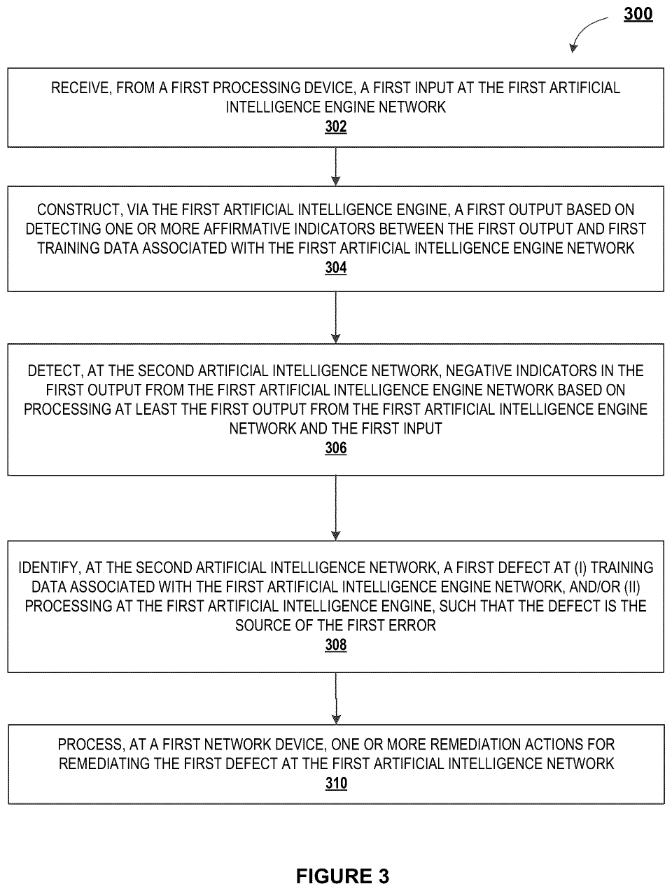

FIG. 3 illustrates a high level process flow 300 for error detection and remediation in artificial intelligence generative engines, in accordance with some embodiments of the invention, which alleviates the deficiencies of and provides improvements to the technology of conventional systems. Some or all of the steps described herein with respect to process flow 300 may be performed by the system 106 (also referred to as “the system”), e.g., via processing device 138 based on executing the computer-readable code 142 (also referred to as computer-readable code 142).

First, as indicated by block 302, the system may receive, from a first processing device 204, a first input at the first artificial intelligence engine network 108A. Next, as indicated by block 304, the system may construct, via the first artificial intelligence engine 240A, a first output based on detecting one or more affirmative indicators between the first output and first training data associated with the first artificial intelligence engine network 108A. In some embodiments, affirmative indicator processing typically involves evaluating the engine's outputs based on how well the outputs match/align with expected results (e.g., expected results based on the training data).

Here, the system may capture, via the second artificial intelligence engine network 108B, the first output from the first artificial intelligence engine network 108A to a downstream processing network 260. Next, as indicated by block 306, the system may detect, at the second artificial intelligence engine network 108B, negative indicators in the first output from the first artificial intelligence engine network 108A based on processing at least the first output from the first artificial intelligence engine network 108A and the first input. The negative indicators may be associated with identifying indicators that indicate that the first output is untrue or inaccurate or defective. Here, the system may, based on the identified negative indicators, identify, at the second artificial intelligence engine network 108B a first error associated with the first artificial intelligence engine 240A.

Here, the system may transmit, by the second artificial intelligence engine network 108B, an interrogatory input to the first artificial intelligence engine 240A structured to trigger a response from the first artificial intelligence engine 240A regarding (i) source data utilized to generate the first output, and/or (ii) one or more discarded solutions associated with the first input. In this way, the system may identify where the training processes as well as the training data may be selective or skewed. For instance, by analyzing the source data utilized to generate the first output, the system may evaluate whether the skewed nature of the source data is the cause/reason for the defective output. Similarly, the system may analyze other solutions generated by the first artificial intelligence engine 240A for the first input, that were generated but were discarded or not chosen as the first output. Upon identifying a more accurate output in the discarded solutions the system may determine that the defect is associated with the processes/training of the first artificial intelligence engine 240A.

Moreover, the system may detecting the negative indicators by: dividing, at the second artificial intelligence engine network 108B, the first output into a plurality of first output components; identifying first ground truth data associated at least one output component of the plurality of first output components; determining a deviation between the first ground truth data and the at least one output component of the plurality of first output components; and detecting the negative indicators in the first output based on determining that the deviation between the first ground truth data and the at least one output component is above a deviation degree threshold.

In some embodiments, the deviation may be determined based on ascertaining the string similarities between the at least one output component of the plurality of first output components and ground truth data. In some embodiments, the deviation may be determined based on aggregating number of rows of the at least one output component of the plurality of first output components that either match or do not match labels in ground truth data.

As discussed, the first artificial intelligence engine network 108A suggests solutions based upon affirmative indicators, while the second artificial intelligence engine network 108B seeks to challenge solutions based upon negative indicators. In one instance, the system may determine a high probability of accuracy of the first output based upon known facts, based on identifying a high degree of affirmative indicators in the first output. The system may further determine a low probability of inaccuracy based upon known facts, and hence a low degree of negative indicators. Here, the system may determine that the first output is likely to be accurate/correct.

In another instance, the system may determine a high probability of accuracy of the first output based upon known facts, based on identifying a high degree of affirmative indicators in the first output. The system may further determine a high probability of inaccuracy based upon known facts, and hence a high degree of negative indicators. Here, the system may determine that, even though there is a high volume of data, the first output is likely to be inaccurate.

In yet another instance, the system may determine a low probability of accuracy of the first output based upon known facts, based on identifying a low degree of affirmative indicators in the first output. The system may further determine a low probability of inaccuracy based upon known facts, and hence a low degree of negative indicators. Here the system may determine that, even though there is low volume of data, the first output is likely to be accurate.

In yet another instance, the system may determine a low probability of accuracy of the first output based upon known facts, based on identifying a low degree of affirmative indicators in the first output. The system may further determine a high probability of inaccuracy based upon known facts, and hence a high degree of negative indicators. Here the system may determine that the first output is likely to be wrong.

At block 308, the system may identify, at the second artificial intelligence engine network 108B, a first defect at (i) training data associated with the first artificial intelligence engine network 108A, and/or (ii) processing at the first artificial intelligence engine 240A, such that the defect is the source of the first error. In this way, the system may identify where the training processes as well as the training data may be selective or skewed. For instance, by analyzing the source data utilized to generate the first output, the system may evaluate whether the skewed nature of the source data is the cause/reason for the defective output. Similarly, the system may analyze other solutions generated by the first artificial intelligence engine 240A for the first input, that were generated but were discarded or not chosen as the first output. Upon identifying a more accurate output in the discarded solutions the system may determine that the defect is associated with the processes/training of the first artificial intelligence engine 240A.

In response to identifying the first defect, the system may block transmission of the first output from the first artificial intelligence engine 240A to the downstream processing network 260. As indicated by block 310, the system may process, at a first network device 154, one or more remediation actions for remediating the first defect at the first artificial intelligence engine network. The remediation actions may involve modifying the training data, e.g., to remove portion or the data or to add additional data to remedy the identified bias/skew in the training data. The remediation actions may involve constructing new training steps to re-train the first artificial intelligence engine 240A to counteract the faulty processes/training.

In some embodiments, the system may insert, at the first output, an error code data in the metadata of the first output prior to transmission of the first output to the downstream processing network 260. Here, the system may transmit the first output from the first artificial intelligence engine 240A to the downstream processing network 260. The downstream processing network 260 identifies the error code data upon processing of the first output, and in response modifies the processing of the first output based on the error code data. Moreover, in some embodiments, the system may capture a second output generated by the first artificial intelligence engine 240A, wherein the second output is generated at a time subsequent to the first output. Here, the system may insert the error code data in the metadata of the first output prior to transmission of the second output to the downstream processing network 260. This ensures that defective data is not inadvertently utilized by downstream systems.

In some embodiments, the system modifies metadata of the first output prior to transmission of the first output to the downstream processing network 260, wherein modifying the metadata of the first output comprises inserting distortions in the metadata such that the first output is unusable by the downstream processing system. This ensures that defective data is not inadvertently utilized by downstream systems.

In some embodiments, the system may transmit, to the first artificial intelligence engine 240A, an operative signal to cause the first artificial intelligence engine 240A to reconstruct the first output based on validating completion of one or more remediation actions for remediating the first defect. Here, the system may construct, at the first artificial intelligence engine 240A, a second output based on the first input and one or more remediation actions for remediating the first defect. The system may validate, at the second artificial intelligence engine network 108B, the second output based on identifying no defects. Subsequently, the system may allow transmission of the second output from the first artificial intelligence engine 240A to the downstream processing network 260 based on successful validation of the second output by the second artificial intelligence engine network 108B. In this way, data processing may be resumed, once the defects in the first artificial intelligence engine 240A are remediated.

In some embodiments, the system may construct a remediation user interface associated with the identified first defect of the first artificial intelligence engine network 108A, wherein the user interface is structured to queue one or more subsequently identified second defects of the first artificial intelligence engine network 108A and associated second outputs from the first artificial intelligence engine network 108A. The system may then present, at a display device of the first network device 154, the remediation user interface, such that the queue is periodically updated, and receive, via the remediation user interface, a first input associated with the first defect of the first artificial intelligence engine network 108A.

In some embodiments, the system may, in response to the first input, remove the block associated with transmission of the first output from the first artificial intelligence engine 240A; and transmit the first output from the first artificial intelligence engine 240A to the downstream processing network 260. In this way, data processing may be resumed, once the defects in the first artificial intelligence engine 240A are remediated.

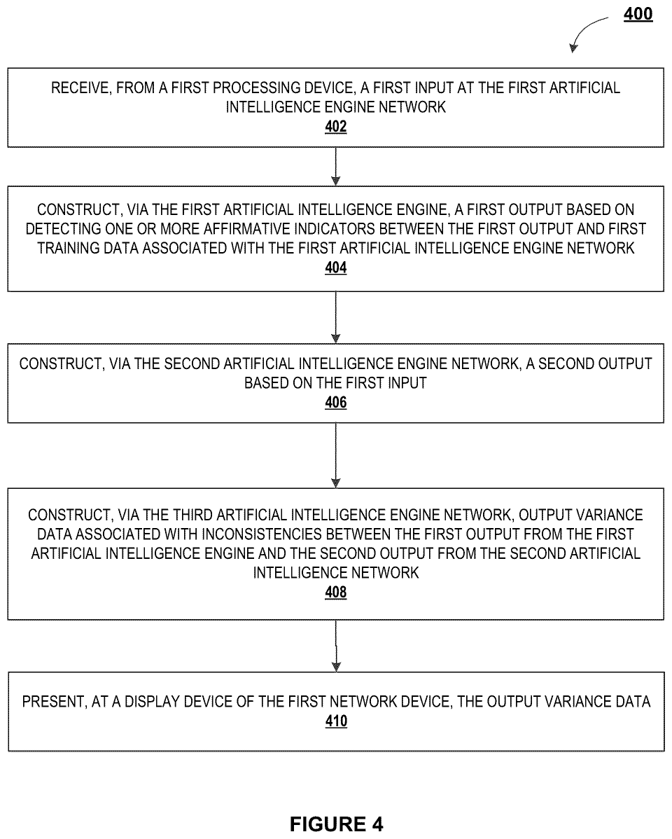

FIG. 4 illustrates a high level process flow 400 for error detection and remediation in artificial intelligence generative engines via variance analysis using a third artificial intelligence engine, in accordance with some embodiments of the invention, which alleviates the deficiencies of and provides improvements to the technology of conventional systems. Some or all of the steps described herein with respect to process flow 300 may be performed by the system 106 (also referred to as “the system”), e.g., via processing device 138 based on executing the computer-readable code 142. Specifically, as illustrated by FIG. 4, the system operatively links to a third artificial intelligence engine network 108C which automatically complete initial variance analysis between the outputs of the first and second AI engines.

First, as indicated by block 402, the system may receive, from a first processing device 204, a first input at the first artificial intelligence engine network 108A. Next, as indicated by block 404, the system may construct, via the first artificial intelligence engine 240A, a first output based on detecting one or more affirmative indicators between the first output and first training data associated with the first artificial intelligence engine network 108A. At block 406, the system may construct, via the second artificial intelligence engine network 108B, a second output based on the first input.

As indicated by block 408, the system may construct, via the third artificial intelligence engine network 108C, output variance data associated with inconsistencies between the first output from the first artificial intelligence engine 240A and the second output from the second artificial intelligence engine network 108B. In some embodiments, the second artificial intelligence engine network 108B may be designated as a baseline reference, against which outputs of the first artificial intelligence engine 240A are evaluated. Here, as a part of the output variance data, the system may generate a similarity score indicating how well the outputs of the first artificial intelligence engine 240A conform to that of the second artificial intelligence engine network 108B. Here, in some embodiments, the output variance data may be generated without utilizing any ground truth data. At block 410, the system may present, at a display device of the first network device 154, the output variance data.

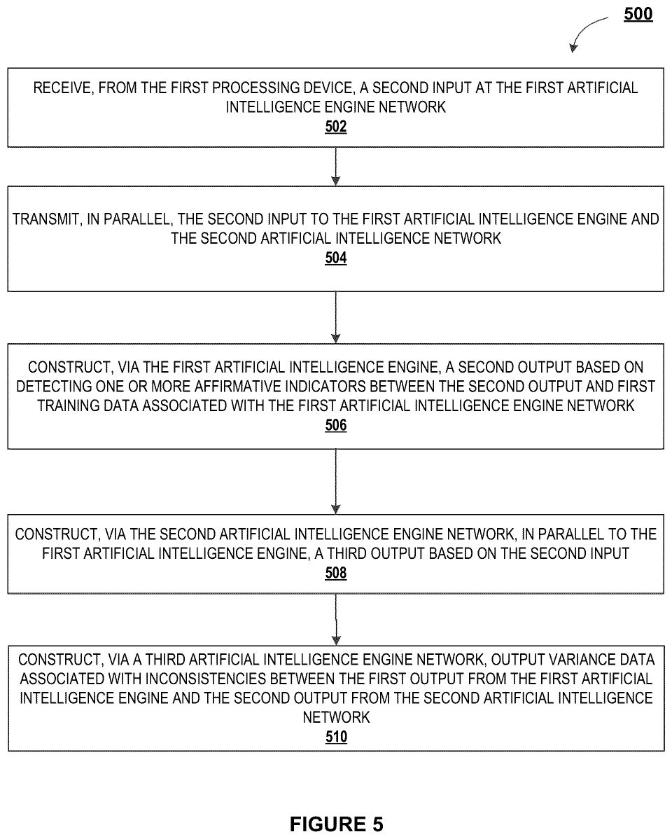

FIG. 5 illustrates a high level process flow 500 for error detection and remediation in artificial intelligence generative engines via parallel processing, in accordance with some embodiments of the invention, which alleviates the deficiencies of and provides improvements to the technology of conventional systems. This parallel processing allows simultaneous generation of outputs which allows for reduced processing time. Moreover, the parallel processing provides parity between the artificial intelligence engine networks (108A, 108B) which allows for evaluating performance metrics such as how quickly each artificial intelligence engine network (108A, 108B) generates the output, how may rounds of inputs are required to refine the results in order to generate a certain output, and how many iterations of inputs are required in order to generate a certain output, for each artificial intelligence engine network (108A, 108B). Some or all of the steps described herein with respect to process flow 300 may be performed by the system 106 (also referred to as “the system”), e.g., via processing device 138 based on executing the computer-readable code 142.

At block 502, the system may receive, from the first processing device 204, a second input at the first artificial intelligence engine network 108A. Next, at block 504, the system may transmit, in parallel, the second input to the first artificial intelligence engine 240A and the second artificial intelligence engine network 108B. At block 506, the system may construct, via the first artificial intelligence engine 240A, a second output based on detecting one or more affirmative indicators between the second output and first training data associated with the first artificial intelligence engine network 108A. At block 508, the system may construct, via the second artificial intelligence engine network 108B, in parallel to the first artificial intelligence engine 240A, a third output based on the second input.

At block 510, the system may construct, via a third artificial intelligence engine network 108C, output variance data associated with inconsistencies between the first output from the first artificial intelligence engine 240A and the second output from the second artificial intelligence engine network 108B. In some embodiments, the second artificial intelligence engine network 108B may be designated as a baseline reference, against which outputs of the first artificial intelligence engine 240A are evaluated. Here, as a part of the output variance data, the system may generate a similarity score indicating the quality of the outputs, i.e., how well the outputs of the first artificial intelligence engine 240A conform to that of the second artificial intelligence engine network 108B. Here, in some embodiments, the output variance data may be generated without utilizing any ground truth data. The system may present, at a display device of the first network device 154, the output variance data.

In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

Although many embodiments of the present invention have just been described above, the present invention may be embodied in many different forms and should not be construed as limited to the embodiments set forth herein, rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F3.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g. a memory) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A system for error detection and remediation in artificial intelligence generative engines, wherein the system is structured for network flow circuit arrangement with counter-processing engine components for localizing errors, detecting inaccurate basis in training data, and validating data generated in a distributed network, the system comprising:
a first artificial intelligence engine network, comprising a first artificial intelligence engine structured for generating output data based on affirmative indicator processing;
a second artificial intelligence engine network operatively connected to the first artificial intelligence engine network, wherein the second artificial intelligence engine network is structured to challenge the first artificial intelligence engine for error detection based on negative indicator processing;
a downstream processing network connected at a location downstream to the first artificial intelligence engine network;
at least one memory device with computer-readable program code stored thereon;
at least one communication device;
at least one processing device operatively coupled to the at least one memory device and the at least one communication device, wherein executing the computer-readable program code is configured to cause the at least one processing device to:
receive, from a first processing device, a first input at the first artificial intelligence engine network;
construct, via the first artificial intelligence engine, a first output based on detecting one or more affirmative indicators between the first output and first training data associated with the first artificial intelligence engine network;
capture, via the second artificial intelligence engine network, the first output from the first artificial intelligence engine network to a downstream processing network;
detect, at the second artificial intelligence engine network, negative indicators in the first output from the first artificial intelligence engine network based on processing at least the first output from the first artificial intelligence engine network and the first input;
based on the identified negative indicators, identify, at the second artificial intelligence engine network a first error associated with the first artificial intelligence engine;
identify, at the second artificial intelligence engine network, a first defect at (i) training data associated with the first artificial intelligence engine network, and/or (ii) processing at the first artificial intelligence engine, such that the first defect is a source of the first error;
in response to identifying the first defect, block transmission of the first output from the first artificial intelligence engine to the downstream processing network; and
process, at a first network device, one or more remediation actions for remediating the first defect at the first artificial intelligence engine network.

2. The system of claim 1, wherein identifying the first error based on the identified negative indicators by the second artificial intelligence engine network further comprises:
transmitting, by the second artificial intelligence engine network, an interrogatory input to the first artificial intelligence engine structured to trigger a response from the first artificial intelligence engine regarding (i) source data utilized to generate the first output, and/or (ii) one or more discarded solutions associated with the first input.

3. The system of claim 1, wherein detecting the negative indicators in the first output by the second artificial intelligence engine network, further comprises:
dividing, at the second artificial intelligence engine network, the first output into a plurality of first output components;
identifying first ground truth data associated at least one output component of the plurality of first output components;
determining a deviation between the first ground truth data and the at least one output component of the plurality of first output components; and
detecting the negative indicators in the first output based on determining that the deviation between the first ground truth data and the at least one output component of the plurality of first output components is above a deviation degree threshold.

4. The system of claim 1, wherein the first artificial intelligence engine network is trained based on a first training mode, and wherein the second artificial intelligence engine network is trained based on a second training mode different from the first training mode.

5. The system of claim 1, wherein blocking transmission of the first output from the first artificial intelligence engine to the downstream processing network further comprises:
inserting, at the first output, an error code data in metadata of the first output prior to transmission of the first output to the downstream processing network;
transmitting the first output from the first artificial intelligence engine to the downstream processing network;
identifying, at the downstream processing network, the error code data upon processing of the first output; and
modifying, at the downstream processing network, the processing of the first output based on the error code data.

6. The system of claim 5, wherein executing the computer-readable program code is configured to cause the at least one processing device to:
capture a second output generated by the first artificial intelligence engine, wherein the second output is generated at a time subsequent to the first output; and
insert, at the second output, the error code data in metadata of the second output prior to transmission of the second output to the downstream processing network.

7. The system of claim 1, wherein blocking transmission of the first output from the first artificial intelligence engine to the downstream processing network further comprises:
modifying metadata of the first output prior to transmission of the first output to the downstream processing network, wherein modifying the metadata of the first output comprises inserting distortions in the metadata such that the first output is unusable by the downstream processing network.

8. The system of claim 1, wherein executing the computer-readable program code is configured to cause the at least one processing device to:
transmit, to the first artificial intelligence engine, an operative signal to cause the first artificial intelligence engine to reconstruct the first output based on validating completion of one or more remediation actions for remediating the first defect;
construct, at the first artificial intelligence engine, a second output based on the first input and one or more remediation actions for remediating the first defect;
validate, at the second artificial intelligence engine network, the second output based on identifying no defects; and
allow transmission of the second output from the first artificial intelligence engine to the downstream processing network based on successful validation of the second output by the second artificial intelligence engine network.

9. The system of claim 1, wherein the system further comprises a third artificial intelligence engine network operatively connected to the first artificial intelligence engine network and the second artificial intelligence engine network, wherein executing the computer-readable program code is configured to cause the at least one processing device to:
construct, via the second artificial intelligence engine network, a second output based on the first input;
construct, via the third artificial intelligence engine network, output variance data associated with inconsistencies between the first output from the first artificial intelligence engine and the second output from the second artificial intelligence engine network; and
present, at a display device of the first network device, the output variance data.

10. The system of claim 1, wherein executing the computer-readable program code is configured to cause the at least one processing device to:
construct a remediation user interface associated with the identified first defect of the first artificial intelligence engine network, wherein the remediation user interface is structured to queue one or more subsequently identified second defects of the first artificial intelligence engine network and associated second outputs from the first artificial intelligence engine network;
present, at a display device of the first network device, the remediation user interface, such that the queue is periodically updated; and
receive, via the remediation user interface, a first input associated with the first defect of the first artificial intelligence engine network.

11. The system of claim 10, wherein the first input is associated with validation of the first output associated with the first defect, wherein executing the computer-readable program code is configured to cause the at least one processing device to:
in response to the first input, remove the block associated with transmission of the first output from the first artificial intelligence engine; and
transmit the first output from the first artificial intelligence engine to the downstream processing network.

12. The system of claim 1, wherein executing the computer-readable program code is configured to cause the at least one processing device to:
receive, from the first processing device, a second input at the first artificial intelligence engine network;
transmit, in parallel, the second input to the first artificial intelligence engine and the second artificial intelligence engine network;
construct, via the first artificial intelligence engine, a second output based on detecting one or more affirmative indicators between the second output and first training data associated with the first artificial intelligence engine network;
construct, via the second artificial intelligence engine network, in parallel to the first artificial intelligence engine, a third output based on the second input;
construct, via a third artificial intelligence engine network, output variance data associated with inconsistencies between the first output from the first artificial intelligence engine and the second output from the second artificial intelligence engine network; and
present, at a display device of the first network device, the output variance data.

13. A computer program product for error detection and remediation in artificial intelligence generative engines, wherein the computer program product is configured for network flow circuit arrangement with counter-processing engine components for localizing errors, detecting inaccurate basis in training data, and validating data generated in a distributed network, the computer program product comprising a non-transitory computer-readable storage medium having computer-executable instructions for causing a computer processor to:
receive, from a first processing device, a first input at a first artificial intelligence engine network, wherein the first artificial intelligence engine network comprises a first artificial intelligence engine structured for generating output data based on affirmative indicator processing;
construct, via the first artificial intelligence engine, a first output based on detecting one or more affirmative indicators between the first output and first training data associated with the first artificial intelligence engine network;
capture, via a second artificial intelligence engine network, the first output from the first artificial intelligence engine network to a downstream processing network, wherein the second artificial intelligence engine network is operatively connected to the first artificial intelligence engine network, wherein the second artificial intelligence engine network is structured to challenge the first artificial intelligence engine for error detection based on negative indicator processing;
detect, at the second artificial intelligence engine network, negative indicators in the first output from the first artificial intelligence engine network based on processing at least the first output from the first artificial intelligence engine network and the first input;
based on the identified negative indicators, identify, at the second artificial intelligence engine network a first error associated with the first artificial intelligence engine;
identify, at the second artificial intelligence engine network, a first defect at (i) training data associated with the first artificial intelligence engine network, and/or (ii) processing at the first artificial intelligence engine, such that the first defect is a source of the first error;
in response to identifying the first defect, block transmission of the first output from the first artificial intelligence engine to a downstream processing network connected at a location downstream to the first artificial intelligence engine network; and
process, at a first network device, one or more remediation actions for remediating the first defect at the first artificial intelligence engine network.

14. The computer program product of claim 13, wherein identifying the first error based on the identified negative indicators by the second artificial intelligence engine network further comprises:
transmitting, by the second artificial intelligence engine network, an interrogatory input to the first artificial intelligence engine structured to trigger a response from the first artificial intelligence engine regarding (i) source data utilized to generate the first output, and/or (ii) one or more discarded solutions associated with the first input.

15. The computer program product of claim 13, wherein detecting the negative indicators in the first output by the second artificial intelligence engine network, further comprises:
dividing, at the second artificial intelligence engine network, the first output into a plurality of first output components;
identifying first ground truth data associated at least one output component of the plurality of first output components;
determining a deviation between the first ground truth data and the at least one output component of the plurality of first output components; and
detecting the negative indicators in the first output based on determining that the deviation between the first ground truth data and the at least one output component of the plurality of first output components is above a deviation degree threshold.

16. The computer program product of claim 13, wherein the non-transitory computer-readable storage medium further comprises computer-executable instructions for causing the computer processor to:
construct a remediation user interface associated with the identified first defect of the first artificial intelligence engine network, wherein the remediation user interface is structured to queue one or more subsequently identified second defects of the first artificial intelligence engine network and associated second outputs from the first artificial intelligence engine network;
present, at a display device of the first network device, the remediation user interface, such that the queue is periodically updated; and
receive, via the remediation user interface, a first input associated with the first defect of the first artificial intelligence engine network.

17. A method for error detection and remediation in artificial intelligence generative engines, wherein the method is configured for network flow circuit arrangement with counter-processing engine components for localizing errors, detecting inaccurate basis in training data, and validating data generated in a distributed network, the method comprising:
receiving, from a first processing device, a first input at a first artificial intelligence engine network, wherein the first artificial intelligence engine network comprises a first artificial intelligence engine structured for generating output data based on affirmative indicator processing;
constructing, via the first artificial intelligence engine, a first output based on detecting one or more affirmative indicators between the first output and first training data associated with the first artificial intelligence engine network;
capturing, via a second artificial intelligence engine network, the first output from the first artificial intelligence engine network to a downstream processing network, wherein the second artificial intelligence engine network is operatively connected to the first artificial intelligence engine network, wherein the second artificial intelligence engine network is structured to challenge the first artificial intelligence engine for error detection based on negative indicator processing;
detecting, at the second artificial intelligence engine network, negative indicators in the first output from the first artificial intelligence engine network based on processing at least the first output from the first artificial intelligence engine network and the first input;
based on the identified negative indicators, identifying, at the second artificial intelligence engine network a first error associated with the first artificial intelligence engine;
identifying, at the second artificial intelligence engine network, a first defect at (i) training data associated with the first artificial intelligence engine network, and/or (ii) processing at the first artificial intelligence engine, such that the first defect is a source of the first error;
in response to identifying the first defect, blocking transmission of the first output from the first artificial intelligence engine to a downstream processing network connected at a location downstream to the first artificial intelligence engine network; and
processing, at a first network device, one or more remediation actions for remediating the first defect at the first artificial intelligence engine network.

18. The method of claim 17, wherein identifying the first error based on the identified negative indicators by the second artificial intelligence engine network further comprises:
transmitting, by the second artificial intelligence engine network, an interrogatory input to the first artificial intelligence engine structured to trigger a response from the first artificial intelligence engine regarding (i) source data utilized to generate the first output, and/or (ii) one or more discarded solutions associated with the first input.

19. The method of claim 17, wherein detecting the negative indicators in the first output by the second artificial intelligence engine network, further comprises:
dividing, at the second artificial intelligence engine network, the first output into a plurality of first output components;
identifying first ground truth data associated at least one output component of the plurality of first output components;
determining a deviation between the first ground truth data and the at least one output component of the plurality of first output components; and
detecting the negative indicators in the first output based on determining that the deviation between the first ground truth data and the at least one output component of the plurality of first output components is above a deviation degree threshold.

20. The method of claim 17, wherein the method further comprises:
construct a remediation user interface associated with the identified first defect of the first artificial intelligence engine network, wherein the remediation user interface is structured to queue one or more subsequently identified second defects of the first artificial intelligence engine network and associated second outputs from the first artificial intelligence engine network;
present, at a display device of the first network device, the remediation user interface, such that the queue is periodically updated; and
receive, via the remediation user interface, a first input associated with the first defect of the first artificial intelligence engine network.
